(19) United States
(12) Patent Application Publication
(10) Pub. No.: US 2010/0213754 A1
(43) Pub. Date: Aug. 26, 2010

(54) Support Systems for a Truck

(75) Inventor: Joseph B. Dirr, Cincinnati, OH (US)

Correspondence Address: DINSMORE & SHOHL LLP, 1900 CHEMED CENTER, 255 EAST FIFTH STREET, CINCINNATI, OH, 45202, US

(73) Assignee: VENTURO, INC., Cincinnati, OH (US)

(21) Appl. No.: 12/707,153

(22) Filed: Feb. 17, 2010

Related U.S. Application Data
(60) Provisional application No. 61/155,420, filed on Feb. 25, 2009.

(51) Int. Cl. B60P 1/28

(52) U.S. Cl. 298/17 B

(57) ABSTRACT

Support systems for a truck having a dump body and a scissors hoist are disclosed. In one embodiment, the scissors hoist is mechanically coupled to the truck at a lower pivot point, mechanically coupled to the dump body at an upper pivot point, and operable to raise and lower the dump body. The support system comprises a prop and a handle, wherein: the prop comprises a pivoting end and a support end, wherein the pivoting end is pivotally coupled to the lower pivot point and permits the prop to be raised and lowered, and, when the prop is raised, the support end is matingly coupled to the dump body at the upper pivot point so as to support the dump body; and the handle is mounted to the truck and mechanically coupled to the prop such that movement of the handle raises and lowers the prop.

### CROSS REFERENCE TO RELATED APPLICATIONS

This application claims the benefit of U.S. Provisional Application 61/155,420, filed on Feb. 25, 2009, which is incorporated herein by reference.

### TECHNICAL FIELD

The present invention generally relates to support systems for a truck and, more specifically, to systems for a truck having a dump body and a scissors hoist.

### BACKGROUND

As background, many trucks are designed to have a dump body capable of being raised or lowered with respect to the truck. The dump body may be operable to receive and carry numerous types of loads, including dirt, gravel, and so forth. The dump body may be lowered when the truck is loaded and while the truck is transporting the load to its destination. Upon reaching the destination, the dump body may be raised in order to unload the contents of the dump body (i.e., the load). As the dump body is raised, the load may slide out of the dump body through the effect of gravity. One mechanism for raising and lowering the dump body may be a scissors hoist, which is typically powered by a hydraulic cylinder and a corresponding hydraulic system. The operation of the scissors hoist may be controlled by an operator via mechanical or electric switches.

Often a person may be required to work within the zone beneath and/or around the raised dump body. This may occur, for example, when the person inspects, services, or repairs the truck, the scissors hoist, and/or the dump body. In these situations, a support system may be installed on the truck which may prevent the dump body from inadvertently being lowered while the person is located within this zone. The dump body could inadvertently be lowered for a number of reasons, including failure of the hydraulic system, failure of the scissors hoist, or if an operator simply lowered the dump body without realizing another person was in this zone.

Accordingly, a need exists for support systems for a truck which can support the dump body, are easy to operate, can be installed on new trucks, and can be retrofitted to older trucks.

### SUMMARY

In one embodiment, a support system is disclosed for a truck having a dump body and a scissors hoist mechanically coupled to the truck at a lower pivot point, mechanically coupled to the dump body at an upper pivot point, and operable to raise and lower the dump body with respect to the truck. The support system comprises a prop and a handle, wherein: the prop comprises a pivoting end and a support end, wherein the pivoting end is pivotally coupled to the lower pivot point so as to permit the prop to be raised and lowered, and, when the prop is raised, the support end is operable to matingly couple to the dump body at the upper pivot point so as to support the dump body; and the handle is mounted to the truck and mechanically coupled to the prop such that movement of the handle is operable to raise and lower the prop.

In another embodiment, a support system is disclosed for a truck having a dump body and a scissors hoist mechanically coupled to the truck at a lower pivot point, mechanically coupled to the dump body at an upper pivot point, and operable to raise and lower the dump body with respect to the truck. The support system comprises a prop and an indexing plate, wherein: the prop comprises a pivoting end, an indexing pin, and a support end, wherein: the pivoting end comprises a slot pivotally coupled to the lower pivot point so as to permit the prop to be raised and lowered, and, when the prop is raised, the support end is operable to matingly couple to the dump body at the upper pivot point so as to support the dump body, the slot is further slidingly coupled to the lower pivot point so as to permit the prop to move radially toward or away from the lower pivot point, and the indexing pin is mounted to the prop and protrudes along an axis substantially parallel with the lower pivot point and is operable to matingly couple to a receiving notch of the indexing plate; and the indexing plate comprises a lifting surface and the receiving notch, wherein: the indexing plate is mounted to the truck at the lower pivot point, the lifting surface is operable to engage the indexing pin such that the prop is moved radially away from the lower pivot point when the prop is raised, the receiving notch is operable to matingly couple to and capture the indexing pin when the prop is raised to a position to permit the dump body to be matingly lowered on the support end of the prop at the upper pivot point, and the indexing pin may be disengaged from the receiving notch by moving the prop radially away from the lower pivot point.

In yet another embodiment, a method is disclosed for engaging a support system for a truck having a dump body and a scissors hoist mechanically coupled to the truck at a lower pivot point, mechanically coupled to the dump body at an upper pivot point, and operable to raise and lower the dump body with respect to the truck, and wherein the support system comprises a prop, a handle, and an upper limiter, wherein: the prop comprises a pivoting end and a support end, wherein the pivoting end is pivotally coupled to the lower pivot point so as to permit the prop to be raised and lowered, and, when the prop is raised, the support end is operable to matingly couple to the dump body at the upper pivot point so as to support the dump body; the handle is mounted to the truck and mechanically coupled to the prop such that movement of the handle is operable to raise and lower the prop; and the upper limiter operable to stop the raising of the prop at a position to permit the dump body to be matingly lowered onto the support end of the prop at the upper pivot point. The method comprises: raising the dump body to a height sufficient to permit the prop to be raised and positioned to support the dump body, moving the handle in a direction to raise the prop until movement of the handle is stopped by the upper limiter, and lowering the dump body onto the prop such that the prop supports the dump body.

These and additional features provided by the embodiments of the present invention will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 depicts a support system for a truck having a dump body and a scissors hoist according to one or more embodiments shown and described herein;

FIG. 2 depicts a support system for a truck having a dump body and a scissors hoist according to one or more embodiments shown and described herein;

FIG. 3 depicts a handle for a support system for a truck having a dump body and a scissors hoist according to one or more embodiments shown and described herein;

FIG. 4 depicts a support system for a truck having a dump body and a scissors hoist according to one or more embodiments shown and described herein;

FIG. 5 depicts a support system for a truck having a dump body and a scissors hoist according to one or more embodiments shown and described herein;

FIG. 6 depicts a support system for a truck having a dump body and a scissors hoist according to one or more embodiments shown and described herein;

FIGS. 7 and 8 depict a prop and an indexing plate for a support system according to one or more embodiments shown and described herein; and

FIGS. 9A, 9B, and 10 depict a prop for a support system for a truck having a dump body and a scissors hoist according to one or more embodiments shown and described herein.

### DETAILED DESCRIPTION

As used herein, the word “truck” means any type of vehicle which is capable of supporting a dump body and a scissors hoist. Such vehicles may include, but are not limited to, a pick-up truck, a flat-bed truck, a dump truck, and a trailer. It is contemplated that the support systems described herein may be applied to trucks (and corresponding dump bodies) of various sizes.

Embodiments generally relate to support systems for a truck having a dump body and a scissors hoist. The dump body may be pivotally attached to the truck such that the scissors hoist is operable to raise and lower the dump body with respect to the truck. The support systems for the truck may operable to support the dump body when it is raised, even in the event of failure of the scissors hoist or the corresponding hydraulic system.

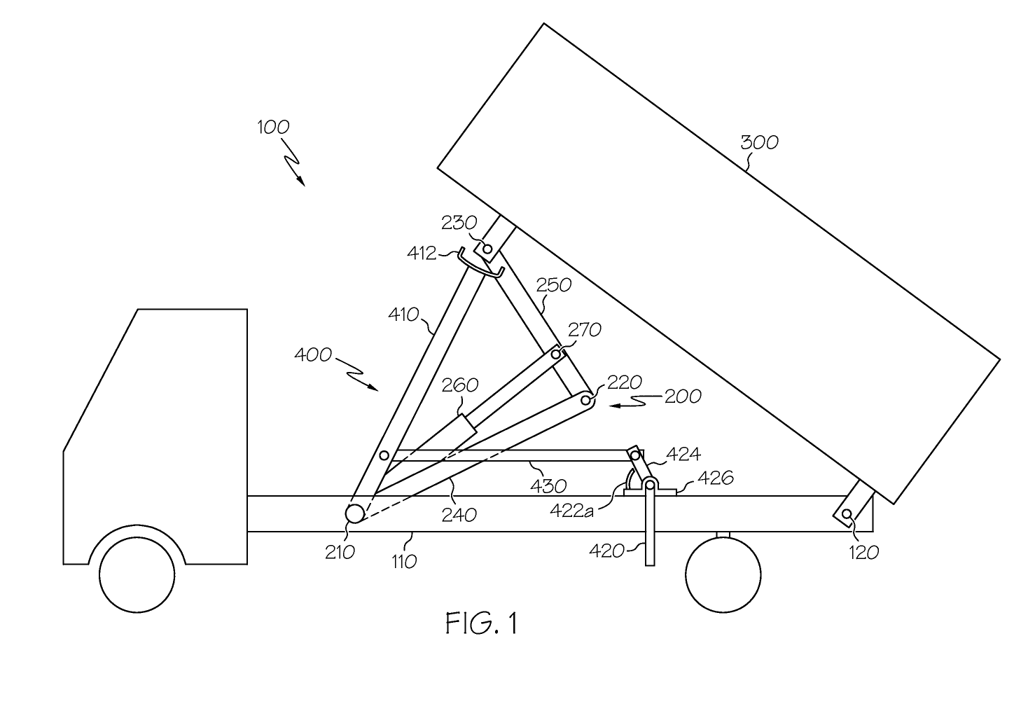

FIG. 1 generally depicts one embodiment of a support system for a truck. The truck 100 may have a scissors hoist 200, a dump body 300, and a support system 400. The truck may comprise a frame member 110 and a dump body pivot point 120, about which the dump body 300 is able to pivot when it raised and lowered. The truck 100 may have more than one frame member 110 which may extend from the front of the truck 100 to the rear of the truck 100. Other components, such as the engine, suspension, and cab may also be attached to the frame member(s). Other variations in the design of the truck and corresponding frame member(s) are contemplated.

As shown in FIG. 1, the scissors hoist 200 may comprise a lower arm 240, an upper arm 250, and a cylinder 260. The lower arm 240 may be mechanically coupled to the frame member 110 at the lower pivot point 210 and to the upper arm 250 at the center pivot point 220. The upper arm 250 may be mechanically coupled to the dump body 300 at the upper pivot point 230. The cylinder 260 may be mechanically coupled to the truck frame member 110 at the lower pivot point 210 and may be mechanically coupled to the upper arm 250 at the cylinder pivot point 270. The cylinder 260 may linearly extend and retract, thus causing the scissors hoist 200 to raise or lower the dump body 300. The cylinder 260 may operate via pressurized hydraulic fluid generated by a corresponding hydraulic system (not shown), as is known to those skilled in the art. The relative lengths and locations of the various components of the scissors hoist 200, as shown in FIG. 1, are exemplary in nature. Other embodiments and styles of the scissors hoist are contemplated.

Referring still to FIG. 1, the cylinder 260 may control the raising and lowering of the dump body 300. When the cylinder 260 is retracted, the upper arm 250 may rotate counterclockwise about the center pivot point 220 such that the dump body 300 (via the upper pivot point 230) is lowered. When the cylinder 260 is fully retracted, the dump body 300 may be lowered such that it is essentially in a horizontal position and may rest on the truck frame member 110. Conversely, when the cylinder 260 is extended, the upper arm 250 may rotate clockwise about the center pivot point 220 such that the dump body 300 (via the upper pivot point 230) is raised. When the cylinder 260 is fully extended, the dump body 300 may be raised to its maximum position with respect to the truck 100. FIG. 1 may show the dump body 300 in a partially raised position. As previously discussed herein, the operation of the cylinder 260 may be controlled via pressurized hydraulic fluid, as is known to those skilled in the art.

The scissors hoist 200 may be mechanically coupled to the truck 100 at the lower pivot point 210. An axle or other similar device (not shown) may be used to mechanically couple the scissors hoist 200 to the truck's frame member 110 at the lower pivot point. For example, an axle may be disposed between two truck frame members in order to form the lower pivot point 210. The axle may be fixedly attached to the frame members and may be operable to support the weight of the dump body 300 and the scissors hoist 200. The lower arm 240 of the scissors hoist 200 may by pivotally coupled to the axle such that the lower arm 240 is permitted to pivot about the lower pivot point 210 as the dump body 300 is raised and lowered. In addition, the cylinder 260 may be pivotally coupled to the axle such that it is also permitted to pivot about the lower pivot point 210 as the dump body 300 is raised and lowered.

The scissors hoist 200 may be coupled to the dump body 300 at the upper pivot point 230. An axle or other similar device (not shown) may be used to mechanically couple the dump body 300 to the scissors hoist 200 at the upper pivot point 230. For example, an axle may be disposed on the dump body 300 in order to form the upper pivot point 230. The axle may be fixedly attached to the dump body 300 at one or more locations and may be operable to support the weight of the dump body 300 and any load contained therein. The upper arm 250 of the scissors hoist 200 may by pivotally coupled to the axle such that the upper arm 250 is permitted to pivot about the upper pivot point 230 as the dump body 300 is raised and lowered.

The dump body 300 may assume a variety of shapes and sizes. In FIG. 1, the exemplary dump body 300 shown is a box-type capable of receiving and carrying many different types of loads, including but not limited to dirt and gravel. It is contemplated that other types of dump bodies may be used, such as flat beds. The dump body 300 may be pivotally coupled to the truck's frame member 110 at a dump body pivot point 120 such that the scissors hoist 200 is operable to raise and lower the dump body 300 about the dump body pivot point 120. Although FIG. 1 depicts only one lower arm 240, one upper arm 250, and one cylinder 260, it is contemplated that the scissors hoist 200 may comprise a plurality of any of these elements. For example, another embodiment of a scissors hoist 200 may comprise two lower arms, two upper arms, and one cylinder.

Referring still to FIG. 1, one embodiment of a support system 400 for the truck may comprise a prop 410 and a handle 420. The prop 410 may comprise a pivoting end and a support end. The pivoting end may be pivotally coupled to the lower pivot point 210 such that the prop 410 is operable to pivot about the lower pivot point 210. Raising and lowering the prop 410 may involve rotating the prop 410 about the lower pivot point 210. In the example shown in FIG. 1, the prop 410 may be rotated counterclockwise in order raise it to a suitable position in which it is capable of supporting the dump body 300. Likewise, the prop 410 may be rotated clockwise in order to be lowered to a storage or rest position. The prop 410 may be a straight, elongated beam as shown in the figure. However, other shapes and geometries for the prop 410 may be used as well.

The support end of the prop 410 may comprise a support bracket 412 which is operable to matingly couple to and support the dump body 300 at the upper pivot point 230. Supporting the dump body 300 may include supporting the weight of the dump body 300 as well as any load that may be contained therein (e.g., gravel). The support bracket 412 may be designed to complement the upper pivot point 230 so that the support bracket 412 may be matingly coupled to the upper pivot point 230. Thus, when the dump body 300 is lowered onto the support bracket 412, the support bracket 412 may receive and capture the upper pivot point 230 and prevent the upper pivot point 230 from sliding off the support bracket 412. Although the support bracket 412 is shown in FIG. 1 as having a “U” shape, other shapes and geometries are contemplated which similarly can be matingly coupled to the dump body 300 at the upper pivot point 230.

Continuing to refer to FIG. 1, the support system 400 may further comprise a handle 420 mechanically coupled to the prop 410 such that movement (e.g., rotation) of the handle 420 is operable to raise and lower the prop 410. The handle 420 may be mounted to the truck 100 at the frame member 110 through a handle bracket 426. The handle bracket 426 may permit the handle 420 to be moved and/or rotated by an operator, thus permitting the prop 410 to be raised or lowered accordingly. In the exemplary embodiment shown, rotating the handle 420 counterclockwise may cause the prop 410 to be raised; conversely, rotating the handle 420 clockwise may cause the prop 410 to be lowered. Other types and styles of handles may be used to raise and lower the prop 410 as well.

The prop 410 may be mechanically coupled to the handle 420 by a number of different techniques. In the embodiment shown in FIG. 1, the prop 410 is mechanically coupled to the handle by a connecting rod 430. Thus, movement of the handle 420 is transferred to the prop 410 via the connecting rod 430, and may cause the prop 410 to be raised and lowered as discussed herein. To facilitate this mechanical arrangement, the connecting rod 430 may be mechanically coupled to the handle 420 via a connecting arm 424 which is mechanically coupled to the handle 420. Thus, in this embodiment, movement of the handle 420 is transferred to the connecting arm 424, which is transferred to the connecting rod 430, which is transferred to the prop 410. Other means to mechanically couple the handle 420 to the prop 410 are contemplated, including but not limited to cables, pulleys, and levers.

Still referring to FIG. 1, an upper limiter 422a may be attached to the handle bracket 426 so as to limit the movement of the handle 420 when raising the prop 410. In the embodiment shown in FIG. 1, the connecting arm 424 may hit the upper limiter 422a so as to limit rotation of the handle 420. As a result, when an operator raises the prop 410, the upper limiter 422a may stop the movement of the handle 420 when the prop 410 is in a suitable position to support the dump body 300 (e.g., the support bracket 412 is suitably positioned to be matingly coupled to the upper pivot point 230 and, hence, cause the prop 410 to support the dump body 300).

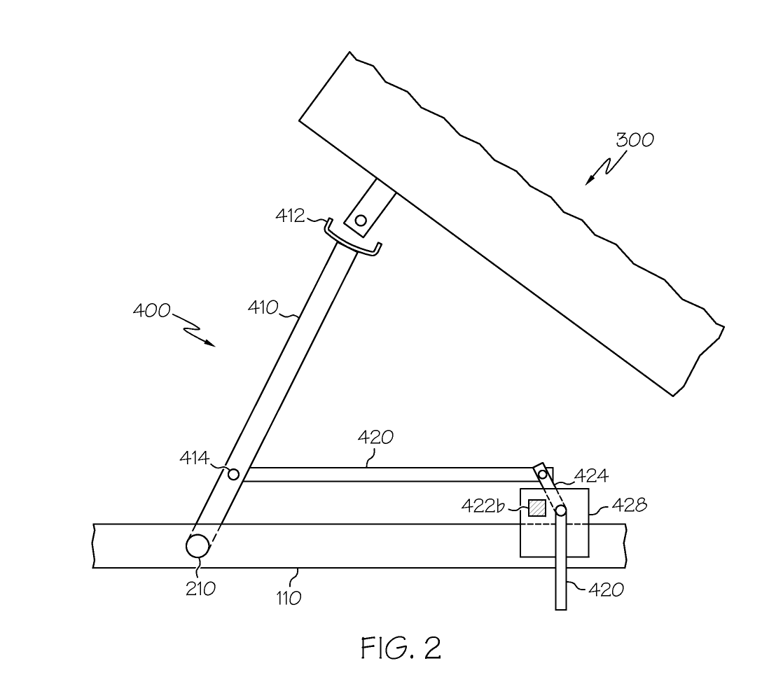

Referring now to FIG. 2, another embodiment of the support system 400 is shown in which the handle 420 is mounted to the frame member 110 via a flat mounting plate 428. The mounting plate 428 may be attached to the frame member 110 and may permit the handle 420 to be moved relative to the frame member 110. A connecting arm 424 may be coupled to the handle 420 to facilitate the transmission of the handle's movement to the prop 410 as previously discussed herein. An upper limiter 422b may be attached to the mounting plate 428 so as to limit the movement of the handle 420 when raising the prop 410. In this embodiment, the upper limiter 422b may comprise a bar which limits the movement of the handle 420 due to the connecting arm 424 reaching the upper limiter 422b. When raising the prop 410, the upper limiter 422b may stop the movement of the handle 420 when the prop 410 is in a suitable position to support the dump body 300.

Referring still to FIG. 2, in order to engage the support system 400, the dump body 300 may be raised to a minimum height by the scissors hoist 200. This may be done through the operation of the cylinder 260 and the hydraulic system (not shown) as discussed herein. The minimum height of the dump body 300 which may allow the support system 400 to be engaged depends primarily on the length of the prop 410. It is contemplated that the prop 410 can assume a variety of lengths. For example, the length of the prop 410 in one embodiment may be one half the maximum height that the dump body 300 can be raised. The length in another embodiment may be the maximum height that the dump body 300 can be raised. Once the dump body 300 is raised to a suitable height for the support system 400 to be engaged (i.e., for the prop 410 to be placed beneath the upper pivot point 230), the dump body 300 may be lowered so that the prop 410 supports some or all of the weight of the dump body 300. In other words, either a portion or all of the dump body weight may be resting on the prop 410, and the scissors hoist may support the remainder of the weight not supported by the prop 410. Note that the weight of the dump body 300 may be transmitted to the prop 410 via the upper pivot point 230. When engaged, the support system 400 may prevent the dump body 300 from being lowered any further, even in the event of a hydraulic or mechanical failure. Consequently, the support system 400 may support the weight of the dump body 300 while a person is working in the zone beneath and/or around the raised dump body. As such, the support system 400, when engaged, may prevent the dump body 300 and the scissors hoist from being lowered.

Referring to both FIGS. 1 and 2, the upper limiter 422a-b may facilitate the raising and positioning of the prop 410. The upper limiter 422a-b may be designed so that the operator may rotate the handle 420 (in this embodiment the rotation is counterclockwise) until the handle 420 reaches the upper limiter 422a-b. At this point, the prop 410 may be in a position such that support bracket 412 is suitably disposed to receive and support the dump body 300 via the upper pivot point 230. In this fashion, the operator may not have to visually inspect or adjust the position of the prop 410; instead, the operator simply rotates the handle 420 until it reaches its mechanical limit (via the upper limiter 422a-b); then the dump body 300 may be lowered onto the prop 410, thus engaging the support system 400. This may simplify the operation of the support system 400 for the operator who may simply have to raise the dump body 300 to a suitable height, rotate the handle 420 of the support system 400 until it is stopped by the upper limiter 422a-b, and finally lower the dump body 300 onto the prop 410. These operations may be performed by one or more operators. For example, one operator may operate the hydraulic system (e.g., to raise and lower the dump body 300 via the scissors hoist 200) while a second operator may engage the support system 400. Alternatively, these operations may be performed by one operator.

In order to disengage the support system 400, the dump body 300 should be raised a suitable amount (e.g. by the scissors hoist 200) so that the support bracket 412 of the prop 410 is able to clear the upper pivot point 230. After the dump body 300 is raised a suitable amount, the prop 410 may be lowered so that the scissors hoist 200 is once again capable of fully lowering the dump body 300. When the prop 410 is lowered, it may be rotated by the handle 420 so that it is disposed to rest on the frame member 110 of the truck, the lower arm 240, a prop rest, or any other suitable component. Similar to the raising procedure, the lowering procedure may be performed by one or more operators.

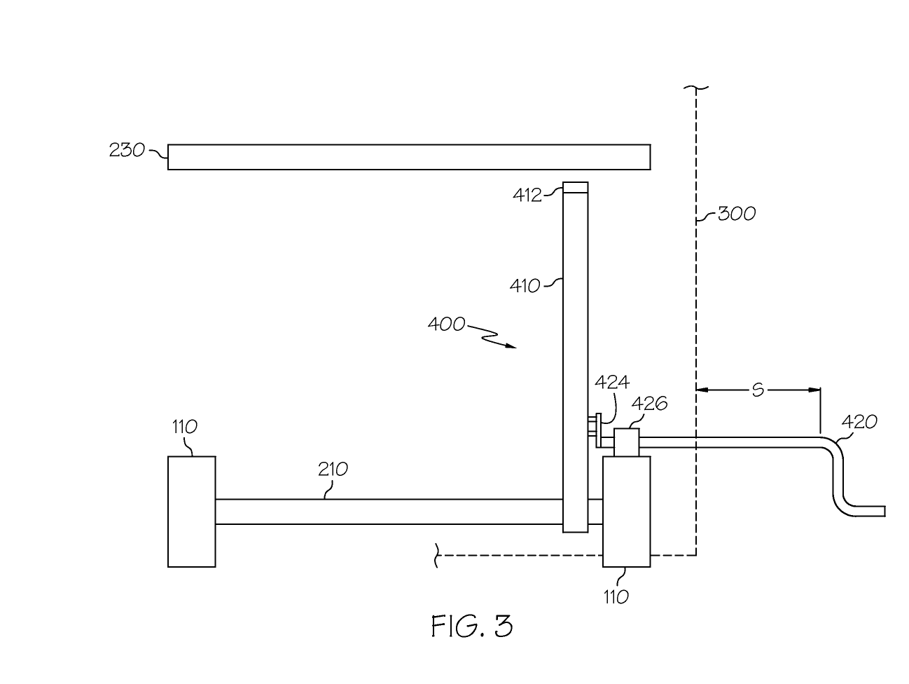

FIG. 3 illustrates a front view of the support system 400 and dump body 300 (i.e., from the front of the truck). In this embodiment, the operator's end of the handle 420 is shown as being disposed a distance S from the lowered position of the dump body 300. The distance S may vary depending on the size of the dump body 300, and it may represent a distance which disposes the operator at a position which lessens the chance that the operator can come into physical contact with dump body 300, even if lowered. In one embodiment, the distance S may be 20 inches. In other embodiments, the distance S may be more or less. If the distance S is 20 inches, the operator of the handle 420 may be disposed approximately 20 inches from the previously-discussed zone created by the scissors hoist and the raised dump body 300. Thus, if the dump body 300 were inadvertently lowered while the operator is attempting to engage or disengage the support system 400, the operator may avoid contact with the scissors hoist and the dump body 300 since he or she should be disposed at least 20 inches from either of them. In this fashion, the embodiment shown may reduce the possibility that the operator can come into contact with the scissors hoist or dump body 300, even while the support system 400 is in the process of being engaged or disengaged.

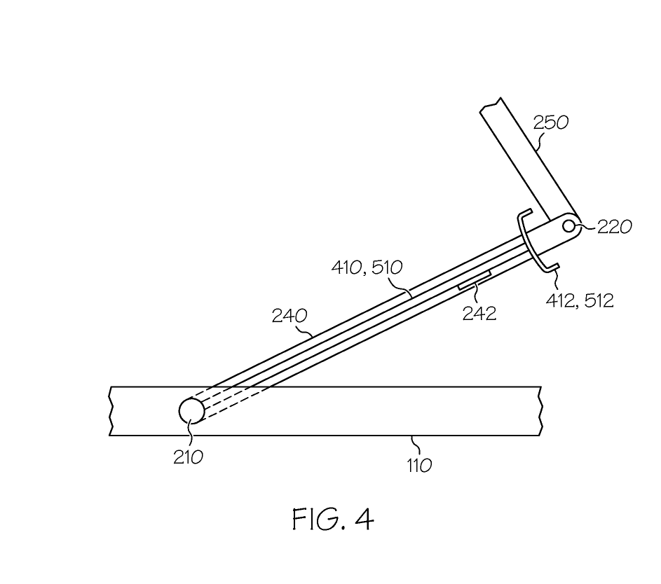

Turning to FIG. 4, when disengaged, the prop 410 may be disposed on a prop rest 242 which may be mechanically coupled to the lower arm 240 of the scissors hoist. Thus, when the operator disengages the support system, the operator may turn the handle until the rotation of the prop 410 is stopped by the prop rest 242, which may include a metal bracket or other suitable device on which the prop 410 may rested. At this point, the operator may not be able to turn the handle any further due to the mechanical interference of the prop rest 242, and he or she may thus recognize that the support system is fully disengaged. When not being used, the prop 410 may continue to rest on the prop rest 242 such as, for example, when the truck is transporting a load. The prop 410, when resting on the prop rest 242, may move up and down with the lower arm 240 as the scissors hoists raises and lowers the dump body (e.g., during normal operation of the truck).

Continuing to refer to FIG. 4, the prop rest 242 may provide a “hard stop” for the handle when the operator wishes to disengage the support system (i.e., lower the prop 410 to the prop rest 242). Referring again to FIGS. 1 and 2, the upper limiter 422a-b also provides a “hard stop” for the prop when the operator wishes to engage the support system (i.e., raise the prop 410 so as to support the dump body 300). As a consequence, these two “hard stops” may provide a simple feedback mechanism for the operator which allows him or her to easily determine when the support system is either fully engaged or fully disengaged without having to perform a visual inspection.

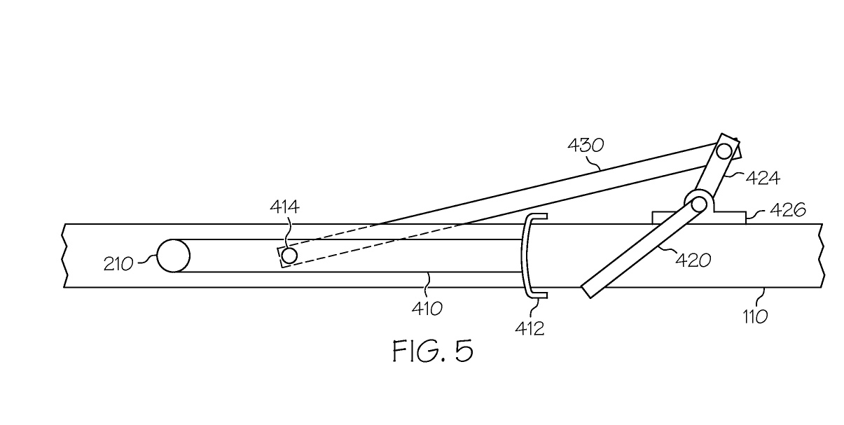

Referring now to FIG. 5, the prop 410 is shown in its disengaged state with the dump body (not shown) in its completely lowered position. Through the operation of the connecting rod 430 and the connecting arm 424, the handle 420 may be in a nearly horizontal position. Other embodiments are contemplated in which the length of the connecting rod 430 may be increased or decreased such that the handle 420 may be in any desired position. In another embodiment, the length of the connecting rod 430 may be adjusted so that the handle 420 is in the vertical position when the support system is fully disengaged and the dump body is completely lowered. In general, many positions of the handle 420 are possible by adjusting the length of the connecting rod 430 and/or the connecting arm 424. Likewise, the position of the handle bracket 426 or mounting plate 428 (with respect to the frame member 110) may also be adjusted to achieve similar objectives. As an example, the operator may desire that the handle 420 be in the horizontal position when fully disengaged (i.e., the prop 410 is lowered onto the prop rest 242) and in the vertical position when fully engaged (i.e., the prop 410 is raised so as to support the dump body 300). In addition, the operator may place placards or labels on the frame member 110 or other part of the truck which provides this information.

Referring again to FIG. 1, the support system 400 only is shown as having one prop 410. Generally, this prop 410 may be disposed on one side of the truck 100 and, in some embodiments, near the truck frame member 110. However, other embodiments may require two or more props. For example, federal or state regulations may require that two props be used if the weight or size of the dump body 300 exceeds a certain value. In such a case, two props may be used, and each may be disposed on each side of the truck or any other suitable locations. In the event two or more props are used, a single handle 420 may be used to engage or disengage all of the props. In this case, the two or more props may be mechanically coupled to the handle 420 such that all props are raised and lowered at the same time.

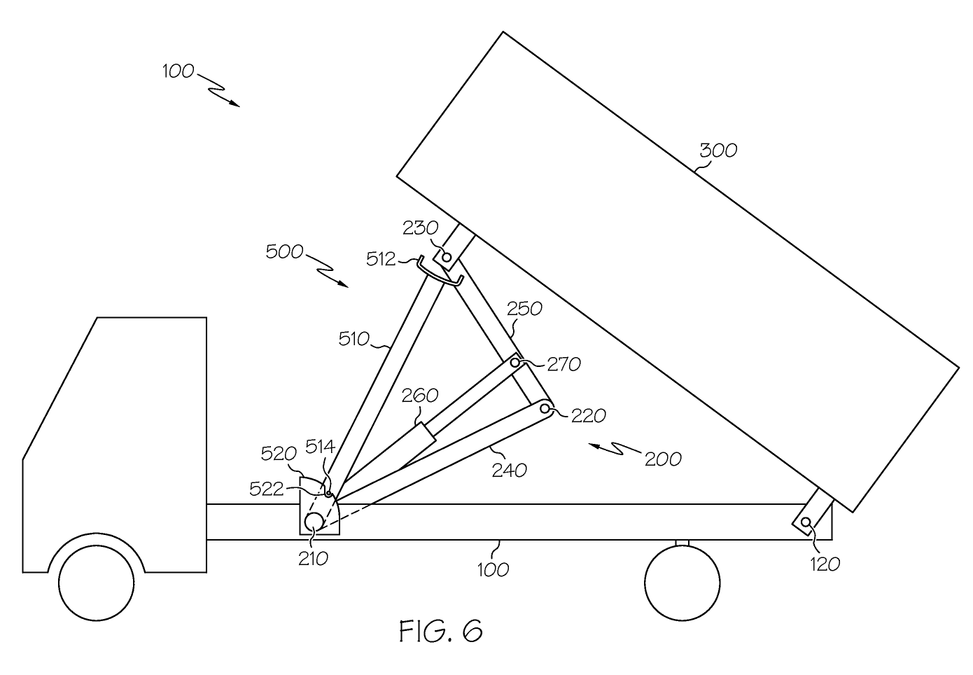

FIG. 6 depicts another embodiment of a support system 500 of a truck 100 having a dump body 300 and a scissors hoist 200. The truck 100, scissors hoist 200, and dump body 300 may operate as previously described herein (e.g., see FIGS. 1-5). The support system 500 in this embodiment may comprise a prop 510 and an indexing plate 520. The prop 510 may comprise a pivoting end, an indexing pin 514, and a support end having a support bracket 512. The prop 510 may be operable to support the dump body 300 when appropriately positioned. The pivoting end of the prop 510 may be pivotally coupled to the lower pivot point 210 so as to permit the prop 510 to pivot about the lower pivot point 210 as the prop 510 is raised and lowered.

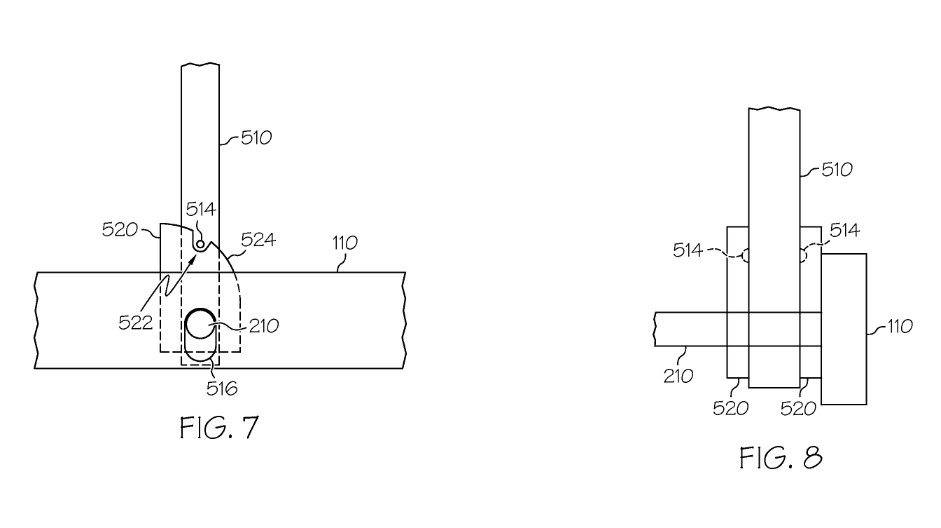

As depicted in FIG. 7, the indexing plate 520 may comprise a receiving notch 522 and a lifting surface 524. The indexing plate 520 may be mounted to the truck frame member 110 at the lower pivot point 210. The receiving notch 522 may be operable to matingly couple to the indexing pin 514 of the prop 510 such that, when the prop 510 is raised to a suitable position, the indexing pin 514 may engage the receiving notch 522 and capture the prop 510. Once captured, the combination of the indexing pin 514 and receiving notch 522 may maintain the position of the prop 510 without any external force (i.e., it may hold the prop 510 in place). In addition, the indexing pin 514 and receiving notch 522 may be designed such that, when captured, the prop 510 is in a suitable position to accept and support the weight of the dump body 300 and any contents therein.

The operation of the indexing pin 514 and receiving notch 522 may be facilitated by a slot 516 formed in the pivoting end of the prop 510. The slot 516 may be pivotally coupled to the lower pivot point 210 such that the prop 510 is operable to pivot about the lower pivot point 210, as previously described. The slot 516 may also be slidingly coupled to the lower pivot point 210 such that the prop 510 is capable of moving radially toward or away from the lower pivot point 210 within the mechanical limits defined by the slot 516. When the prop is raised, the indexing pin 514 may be engaged by the lifting surface 524 of the indexing plate 520 such that the prop 510 is moved radially (e.g., lifted) away from the lower pivot point 210. Once the indexing pin 514 reaches the receiving notch 522, the prop 510 may drop toward the lower pivot point 210 through the action of gravity or a component (e.g., a spring), thus permitting the prop 510 to be captured and held in place. The design of the slot 516 permits this radial motion by the prop 510 as it is raised and as the indexing pin 514 engages the receiving notch 522.

Referring again to FIG. 6, when an operator wishes to engage the support system 500, the dump body 300 should be raised to a suitable height by the scissors hoist 200 so that the prop 510 may be placed in a suitable position to support the dump body 300. The minimum height of the dump body 300 which may allow to the support system 500 to be engaged may depend primarily on the length of the prop 510. As previously discussed, the prop 510 may assume a number of different lengths and shapes. Once the dump body 300 is raised to a suitable height for the prop 510 to be placed beneath the upper pivot point 230, an operator may manually raise the prop 510 simply by grasping the prop 510 and raising it (i.e., rotating it about the lower pivot point 210). The operator may raise the prop 510 until the indexing pin 514 matingly couples to (i.e., engages) the receiving notch 522. At this point, mechanical interference of the indexing pin 514 and indexing plate 520 may prevent the operator from raising the prop 510 any further. In addition, the prop 510 may noticeably move (e.g., drop) toward the lower pivot point 210 when the indexing pin 514 engages the receiving notch 522, so as to “click” into the fully raised position. These two pieces of information (the fact that the prop cannot be raised any further and/or the corresponding movement of the prop) may provide tactile and audible feedback to the operator indicating that the prop 510 is in a suitable position to receive the dump body 300. Thus, the operator may not have to visually inspect or adjust the prop 510; instead, the operator simply raises the prop 510 until it reaches its mechanical limit. In this fashion, the operation of engaging the support system 500 may be simplified for the operator. After the prop 510 has been raised, the dump body 300 may be lowered onto the prop 510, thus supporting some or all of its weight.

While the prop 510 is engaged, the dump body 300 may be lowered such that some all the weight of the scissor hoist and/or dump body 300 may be placed on the prop 510. Generally, all the weight of the dump body 300 is transmitted to the prop 510 to the upper pivot point 230. The indexing pin 514 and indexing plate 520 may be designed such that none of this weight is transmitted to the indexing pin 514 or the receiving notch 522. Instead the weight of the scissors hoist and/or dump body may be transmitted to the lower pivot point 210 via the slot 516. Thus, the indexing pin 514 may be designed so that it does not have to support any weight of the dump body 300 and, as a consequence, is not likely to be damaged by any of the forces transmitted through the prop 510 by the dump body 300. The indexing pin 514 and receiving notch 522 may simply be designed to hold the prop 510 in a suitable position to receive the dump body 300 and to prevent the operator from raising the prop 510 too far.

Still referring to FIG. 6, in order to disengage the support system 500 (i.e., lower the prop 510), the operator should raise the scissors hoist 200 and dump body 300 a suitable amount so that the support bracket 512 clears the upper pivot point 230. After this is done, the operator may grasp and lift the prop 510 radially away from the lower pivot point 210, thereby disengaging the indexing pin 514 from the receiving notch 522. The operator may then manually lower the prop 510 onto its rest position which, in the embodiment shown, is accomplished by rotating the prop 510 clockwise.

Referring now to FIG. 8, the support system may comprise one or more indexing plates 520. In the embodiment shown in this figure, a front view of the prop 510 and indexing plates 520 are shown. The indexing plates 520 may be placed on each side of the prop 510. Likewise, one or more indexing pins 514 may be disposed on the prop 510 such that each indexing pin 514 may engage the corresponding indexing plate 520. It is contemplated that other embodiments may only employ one indexing plate 520 and corresponding indexing pin 514.

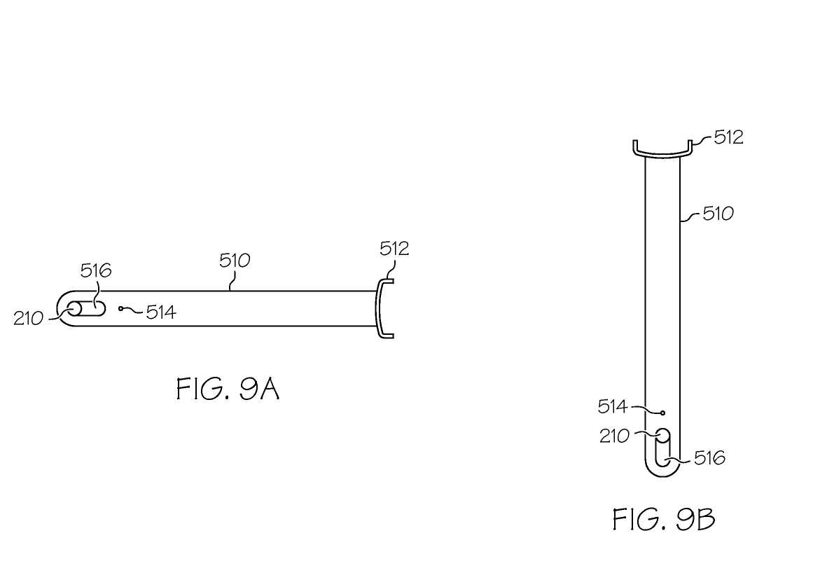

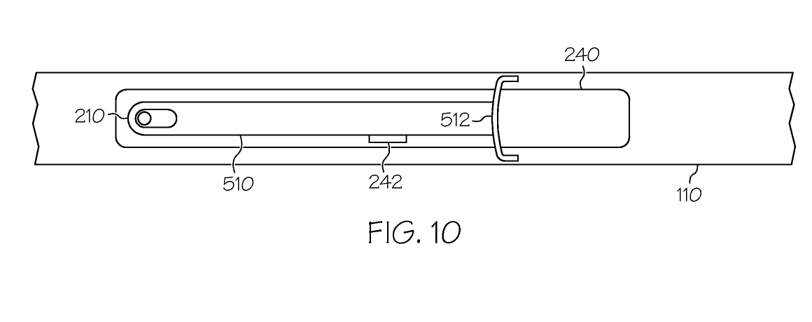

FIGS. 9A, 9B, and 10 depict one embodiment of the prop 510 and the slot 516. FIG. 9A shows the prop 510 when the support system 500 is fully disengaged (i.e., the prop 510 is lowered, for example, on the prop rest). In this state, the prop 510 may be moved to one end of the slot 516 such that the prop 510 is moved radially away from the lower pivot point 210 to the extent permitted by the slot 516. In addition, the prop 510 may be disposed on a prop rest 242 (shown in FIG. 10) which may be mechanically coupled to the lower arm 240 of the scissors hoist. Thus, when the operator disengages the support system, the operator may lower the prop 510 so as to rest on the prop rest 242. This simple operation allows the operator to quickly disengage the support system.

In FIG. 9B, the prop 510 is shown in its raised position. Here, the indexing pin 514 may be matingly coupled to the receiving notch (not shown). In this position, the prop 510 may be radially disposed such that the prop 510 is disposed to be as close to the lower pivot point 210 as permitted by the slot 516. This may be caused by gravity, which may pull the prop 510 radially toward the lower pivot point 210 when the indexing pin 514 is matingly coupled to the receiving notch.

In FIG. 10, the prop rest 242 provides a “hard stop” for the prop 510 when the operator wishes to disengage the support system (i.e., lower the prop 510 to the prop rest 242). Referring back to FIG. 7, the receiving notch 522 and indexing pin 514 combination may provide a “hard stop” for the prop 510 when the operator wishes to engage the support system (i.e., raise the prop 510 so as to support the dump body). As a consequence, these two “hard stops” may provide a simple feedback mechanism for the operator which allows him or her to easily determine when the support system is either fully engaged or fully disengaged without having to perform a visual inspection.

In FIG. 10, the prop 510 is shown in its disengaged state with the dump body (not shown) in its completely lowered position. In this state, the prop 510 may rest on the prop rest 242. This may keep the prop 510 in a position which does not interfere with the normal operation of the scissors hoist and dump body. It is contemplated that other rest positions may be selected as well.

In yet another embodiment, the support system 500 of FIG. 6 may be combined with the handle mechanism of FIG. 2. Thus, the handle 420 may be mechanically coupled to the prop 510 such that movement (e.g., rotation) of the handle 420 operates to raise the prop 510. The indexing plate 520, indexing pin 514, and receiving notch 522 may operate as before and 1) Limit the rotation of the prop 510 as it is being raised, and 2) Cause the prop 510 to lock into a suitable position to receive the dump body 300. However, in this embodiment, lowering the prop 510 may have to be performed by the operator grasping the prop 510, lifting it, and manually lowering it. Thus, in this embodiment, the handle 420 may be used only to raise the prop 510.

It should now be understood that the systems and methods described herein may be used to provide a support system for a truck having a dump body and a scissors hoist. In particular, the support systems may be able to support the weight of the scissors hoist, the dump body, and any contents of the dump body. Likewise, the methods described herein may be used to quickly engage and disengage the support system as well as provide feedback to the operator that the system is fully engaged or fully disengaged.

While particular embodiments and aspects of the present invention have been illustrated and described herein, various other changes and modifications may be made without departing from the spirit and scope of the invention. Moreover, although various inventive aspects have been described herein, such aspects need not be utilized in combination. It is therefore intended that the appended claims cover all such changes and modifications that are within the scope of this invention

What is claimed is:

1. A support system for a truck having a dump body and a scissors hoist mechanically coupled to the truck at a lower pivot point, mechanically coupled to the dump body at an upper pivot point, and operable to raise and lower the dump body with respect to the truck, the support system comprising a prop and a handle, wherein:
the prop comprises a pivoting end and a support end, wherein the pivoting end is pivotally coupled to the lower pivot point so as to permit the prop to be raised and lowered, and, when the prop is raised, the support end is operable to matingly couple to the dump body at the upper pivot point so as to support the dump body; and
the handle is mounted to the truck and mechanically coupled to the prop such that movement of the handle is operable to raise and lower the prop.

2. The system of claim 1, wherein the handle is disposed a sufficient distance from the truck such that the dump body is not able to come in contact with an operator of the handle.

3. The system of claim 1, further comprising an upper limiter operable to stop the raising of the prop at a position to permit the dump body to be matingly lowered onto the support end of the prop at the upper pivot point.

4. The system of claim 1, further comprising a prop rest mechanically coupled to the scissors hoist and operable to stop the lowering of the prop.

5. The system of claim 4, wherein the prop rest supports the prop when the prop is not being used to support the dump body.

6. The system of claim 1, further comprising an additional prop having an additional pivoting end and an additional support end, and wherein:
the additional pivoting end is pivotally coupled to the lower pivot point so as to permit the additional prop to be raised and lowered;
when the prop is raised, the additional support end is operable to matingly couple to the dump body at the upper pivot point so as to support the dump body; and
the handle is mechanically coupled to the additional prop such that the prop and the additional prop are raised and lowered together.

7. The system of claim 1, wherein the support end of the prop comprises a support bracket.

8. The system of claim 1, wherein movement of the handle to raise and lower the prop is rotation of the handle.

9. A support system for a truck having a dump body and a scissors hoist mechanically coupled to the truck at a lower pivot point, mechanically coupled to the dump body at an upper pivot point, and operable to raise and lower the dump body with respect to the truck, the support system comprising a prop and an indexing plate, wherein:
the prop comprises a pivoting end, an indexing pin, and a support end, wherein:
the pivoting end comprises a slot pivotally coupled to the lower pivot point so as to permit the prop to be raised and lowered, and, when the prop is raised, the support end is operable to matingly couple to the dump body at the upper pivot point so as to support the dump body,
the slot is further slidingly coupled to the lower pivot point so as to permit the prop to move radially toward or away from the lower pivot point, and
the indexing pin is mounted to the prop and protrudes along an axis substantially parallel with the lower pivot point and is operable to matingly couple to a receiving notch of the indexing plate; and
the indexing plate comprises a lifting surface and the receiving notch, wherein:
the indexing plate is mounted to the truck at the lower pivot point,
the lifting surface is operable to engage the indexing pin such that the prop is moved radially away from the lower pivot point when the prop is raised,
the receiving notch is operable to matingly couple to and capture the indexing pin when the prop is raised to a position to permit the dump body to be matingly lowered on the support end of the prop at the upper pivot point, and
the indexing pin may be disengaged from the receiving notch by moving the prop radially away from the lower pivot point.

10. The system of claim 9, further comprising a prop rest mechanically coupled to the scissors hoist and operable to stop the lowering of the prop.

11. The system of claim 10, wherein the prop rest supports the prop when the prop is not being used to support the dump body.

12. The system of claim 9, wherein the support end of the prop comprises a support bracket.

13. The system of claim 9, further comprising a handle mounted to the truck and mechanically coupled to the prop such that movement of the handle is operable to raise the prop.

14. The system of claim 13, wherein the handle is disposed a sufficient distance from the truck such that the dump body is not able to come in contact with an operator of the handle.

15. The system of claim 13, wherein movement of the handle to raise the prop is rotation of the handle.

16. A method for engaging a support system for a truck having a dump body and a scissors hoist mechanically coupled to the truck at a lower pivot point, mechanically coupled to the dump body at an upper pivot point, and operable to raise and lower the dump body with respect to the truck, wherein the support system comprises a prop, a handle, and an upper limiter, wherein: the prop comprises a pivoting end and a support end, wherein the pivoting end is pivotally coupled to the lower pivot point so as to permit the prop to be raised and lowered, and, when the prop is raised, the support end is operable to matingly couple to the dump body at the upper pivot point so as to support the dump body; the handle is mounted to the truck and mechanically coupled to the prop such that movement of the handle is operable to raise and lower the prop; and the upper limiter operable to stop the raising of the prop at a position to permit the dump body to be matingly lowered onto the support end of the prop at the upper pivot point, and wherein the method comprises:
raising the dump body to a height sufficient to permit the prop to be raised and positioned to support the dump body,
moving the handle in a direction to raise the prop until movement of the handle is stopped by the upper limiter, and
lowering the dump body onto the prop such that the prop supports the dump body.

17. The method of claim 16, wherein the handle is disposed a sufficient distance from the truck such that the dump body is not able to come in contact with an operator of the handle.

18. The method of claim 16, wherein the support system further comprises an additional prop having an additional pivoting end and an additional support end, wherein:
the additional pivoting end is pivotally coupled to the lower pivot point so as to permit the additional prop to be raised and lowered;
when the prop is raised, the additional support end is operable to matingly couple to the dump body at the upper pivot point so as to support the dump body; and
the handle is mechanically coupled to the additional prop such that the prop and the additional prop are raised and lowered together.
